(19) United States
(12) Patent Application Publication
(10) Pub. No.: US 2011/0171361 A1
(43) Pub. Date: Jul. 14, 2011

(54) BASE BROTH POWDER AND METHOD FOR PRODUCING THE SAME

(75) Inventors: Se-Hyun Jung, Seoul (KR); In-Duck Yoon, Incheon (KR); Won-Dae Chung, Seoul (KR)

(73) Assignee: CJ CHEILJEDANG CORP., Seoul (KR)

(21) Appl. No.: 13/003,169

(22) PCT Filed: Jul. 1, 2009
(86) PCT No.: PCT/KR2009/003600

§ 371 Date: Apr. 1, 2011

(30) Foreign Application Priority Data
Jul. 7, 2008 (KR) 10-2008-0065531

(51) Int. Cl. A23L 1/40

(52) U.S. Cl. 426/589

(57) ABSTRACT

Provided are a base broth powder produced by mixing a concentrate extracted from anchovies, shrimp, shellfish, radishes, onions and cabbage, an extract powder from anchovies, dried pollock, kelp and green onions and a ground powder of anchovies and gelatinized rice, freeze-drying the resulting mixture and grinding the resultant to powder, and a method of producing the base broth powder. Therefore, the base broth powder may be useful in producing a strong base broth without complicated procedures in a short time, and obtaining a product that can be stored in small disposable packs for a prolonged time. Also, the base broth powder may satisfy the consumers' latest trend of pursuing convenience by eliminating a troublesome procedure of boiling a variety of materials over a long time during cooking of broth, improve sensory properties including a rich taste and a strong anchovy taste compared to conventional products, and ensure a great degree of storability that may not be ensured by the conventional methods or in the conventional products.

### REFERENCE TO RELATED APPLICATIONS

This application is a national stage application under 35 USC 371 of International Application No. PCT/KR2009/003600, filed Jul. 1, 2009, which claims the priority of Korean Application No. 10-2008-0065531, filed Jul. 7, 2008, the contents of which prior applications are incorporated herein by reference.

### FIELD OF THE INVENTION

The present invention relates to a powder composition for making base broth (hereinafter, referred to as ‘base broth powder composition’) and a method of producing the same, and more particularly, to a base broth powder composition produced by mixing a concentrate extracted from anchovies, shrimp, shellfish, radishes, onions and cabbage, an extract powder of anchovies, dried pollock, kelp and green onions, and a ground powder of anchovies and gelatinized rice, freeze-drying the mixture and grinding it into powder, and a method of producing the same.

### BACKGROUND OF THE INVENTION

Koreans enjoy a variety of soup, stew or broth (hereinafter, referred to as ‘broth’) to an extent that their food culture could be referred to as broth culture. Traditionally, they have used water obtained in the process of washing rice for making base broth on the purpose of improving taste of broth. As their household income has increased, they have made a base broth by boiling materials like anchovies, kelp and radishes for themselves and use it as base broth. However, it takes too much time and needs inconvenient procedures such as picking the materials out of cooking vessels. In addition, in case of base broth being remained, it may cause difficulty in storage since it should be kept refrigerated or frozen for reuse.

In order to solve these problems, in the case of seafood, a method of grinding each of dried seafood into powder which may be stored for a prolonged time was suggested for making base broth. However, such base broth has a weak taste and powders sink to the ground of cooking vessel to form precipitates, which is not good for appearance.

As to making base broths, Korean Patent Publication No. 10-1998-068012 entitled “Method of preparing buckwheat gravy” discloses a method of preparing buckwheat gravy from skipjack, kelp, onions, green onions, shiitake mushrooms and ginger wherein the materials go well with each other and, at the same time, give their unique tastes. Korean Patent Publication No. 10-2008-0017885 entitled “Composite seasoning containing meat stock powder and katsuobushi powder and method of producing the same” discloses composite seasoning produced by adding water into cow leg bones or meats, tendons, garlic and green onions to obtain washy gravy by the 1^{St} heating procedure, picking the materials out of the washy gravy, concentrating the washy gravy by the 2^{nd} heating procedure, concentrating the obtained gravy in a vacuum concentrator and freeze-drying the gravy. Korean Patent Publication No. 10-2003-0052674 entitled “An anchovy broth stock tea-bag” discloses anchovy broth stock tea-bag prepared by mixing 60 to 80 parts by weight of dried anchovies whose head and entrails are removed, 10 to 30 parts by weight of dried pollock, 10 to 30 parts by weight of dried kelp, 6 to 10 parts by weight of dried onions, 3 to 7 parts by weight of dried mushrooms, 3 to 7 parts by weight of dried garlic and 2 to 6 parts by weight of dried shrimp with stirring to produce a mixture, putting the mixture in a tea-bag made of porous nonwoven filter paper and sealing the tea-bag. However, this method also has problems that the anchovy broth stock tea-bag does not provide a rich taste of base broth, should be removed out of cooking vessel and cannot be stored for a prolonged time. Also, since anchovies even in dried state have fat content of 5 to 10%, it is difficult to store them for more that 6 months due to fat rancidity and microorganism reproduction.

Also, liquid products for making base broth easily which are prepared by hot water extracting raw materials of anchovies, shiitake mushrooms, chili peppers, shrimp, onions, green onions, radishes, peppercorns, dried pollock and kelp, mixing the extracted raw materials and sterilizing the resultant are currently commercially available. However, the products undergo quality deterioration in the process of sterilization and, therefore, hardly provide a rich taste. Further, they are too heavy for handling and the remnants should be kept refrigerated and may go bad easily.

Therefore, it is required to develop a product that provides a strong taste, can be stored for a prolonged time and enables anyone to make base broth easily.

In order to solve the problems of the prior-art base broth, the present inventors have conducted extensive research and experiments and develop a base broth-making product which has a richer taste and can be stored for a prolonged time and enables anyone to make base broth easily. As a result, they invented the base broth powder which has a totally richer taste with a fresh taste derived from concentrate extracted from natural materials, a rich taste derived from an extract powder and a natural taste derived from a ground powder.

### SUMMARY OF THE INVENTION

Therefore, an object of the present invention is to provide a base broth powder composition prepared from 10 (ten) natural materials such as anchovies, dried pollock, shrimp, shellfish, kelp, radishes, onions, cabbage, green onions and rice flour, which has a strong taste and can be stored for a prolonged time and can be used for making base broth in a short time without complicated procedures, and a method of producing the same.

The object of the present invention was achieved by producing a base broth powder by preparing each of an extract concentrate, an extract powder and a ground powder from natural materials used for making base broth, mixing them, freeze-drying the mixture and grinding it into powder, and then by confirming that the base broth powder of the present invention can be stored for a prolonged time, has consistent and fresh taste and enables anyone to make base broth more quickly and conveniently, compared to the conventional methods or products for making base broth.

The present invention provides a method of producing a base broth powder composition using ten (10) natural materials such as anchovies, dried pollock, shrimp, shellfish, kelp, radishes, onions, cabbage, green onions and rice flour.

The method of the present invention includes steps of preparing a concentrate extracted from anchovies, shrimp, shellfish, radishes, onions and cabbage; preparing an extract powder of anchovies, dried pollock, kelp and green onions; preparing a ground powder of anchovies and gelatinized rice; mixing and homogenizing the respective materials; freeze-drying the mixture; and grinding the resultant into powder and packaging it.

The extract concentrate according to the present invention is made to have 55 to 65 Brix by hot water extracting anchovies, shrimp, shellfish, radishes, onions and cabbage, respectively, filtering these materials and concentrating the filtrate under reduced pressure.

The extract powder according to the present invention is made to have 10 to 30 Brix by mixing hot water extracts of anchovies, dried pollock, kelp and green onions and powder of each of anchovies, dried pollock, kelp and green onions, and vacuum-drying the resulting mixture at 80° C.

Also, the ground powder according to the present invention is produced by passing 90% of anchovies through 25 mesh and gelatinizing rice flour by drum-drying.

The extract concentrate, the extract powder and the ground powder prepared separately as described above are mixed in a mixer in a suitable ratio given in the followings, and the resulting mixture is loaded into a drying fan, frozen in a deep freezer, dried under reduced pressure, and ground into powder to produce a base broth powder.

Also, the present invention provides a base broth powder prepared from 10 (ten) natural materials such as anchovies, dried pollock, shrimp, shellfish, kelp, radishes, onions, cabbage, green onions and rice flour, which can be stored for a prolonged time, has a strong taste and enables anyone to make base broth in a short time without complicated procedures.

Preferably, a composition of materials used for making the base broth powder according to the present invention is characterized by consisting of 15 to 45% by weight of seafood including anchovies, dried pollock, shrimp, shellfish and kelp, 50 to 75% by weight of culinary vegetables including radishes, onions, cabbage and green onions and 1 to 5% by weight of gelatinized rice flour.

Further, a composition for the base broth powder according to the present invention is characterized by consisting of 15 to 35% by weight of anchovies, 0.5 to 5% by weight of dried pollock, 0.5 to 5% by weight of shrimp, 0 to 4% by weight of shellfish, 1 to 6% by weight of kelp, 25 to 45% by weight of radishes, 8 to 15% by weight of onions, 12 to 22% by weight of cabbage, 0 to 2% by weight of green onions and 1 to 5% by weight of gelatinized rice flour.

The base broth powder of the present invention as described above is produced by mixing a concentrate extracted from anchovies, shrimp, shellfish, radishes, onions and cabbage, an extract powder of anchovies, dried pollock, kelp and green onions and a ground powder of anchovies and gelatinized flour, freeze-drying the resulting mixture and grinding it into powder. Therefore, it can result in base broth with a richer taste without complicated procedures and can be stored for a prolonged time by packaging them in disposable pack unit and eliminate an inconvenient process of boiling a variety of materials for hours for making base broth. Accordingly, it can satisfy the consumers' latest trend of pursuing convenience. Further, it improves sensory properties by providing a richer taste and stronger anchovy taste compared to conventional methods or products and can ensure storability which can not be achieved from conventional methods or products.

A base broth with a richer taste can be made using the base broth powder according to the present invention in a short time without complicated procedures. Further, the base broth powder can be stored for a prolonged time by packaging them in disposable pack unit and eliminate an inconvenient process of boiling a variety of materials for hours for making base broth, which means that it can satisfy the consumers' latest trend of pursuing convenience. Further, it improves sensory properties by providing a richer taste and stronger anchovy taste compared to conventional methods or products and can ensure storability which can not be achieved from conventional methods or products, which makes the present invention very useful in the food industry.

### BRIEF DESCRIPTION OF THE DRAWINGS

FIG. 1 is a diagram schematically illustrating a method of producing a base broth powder of the present invention.

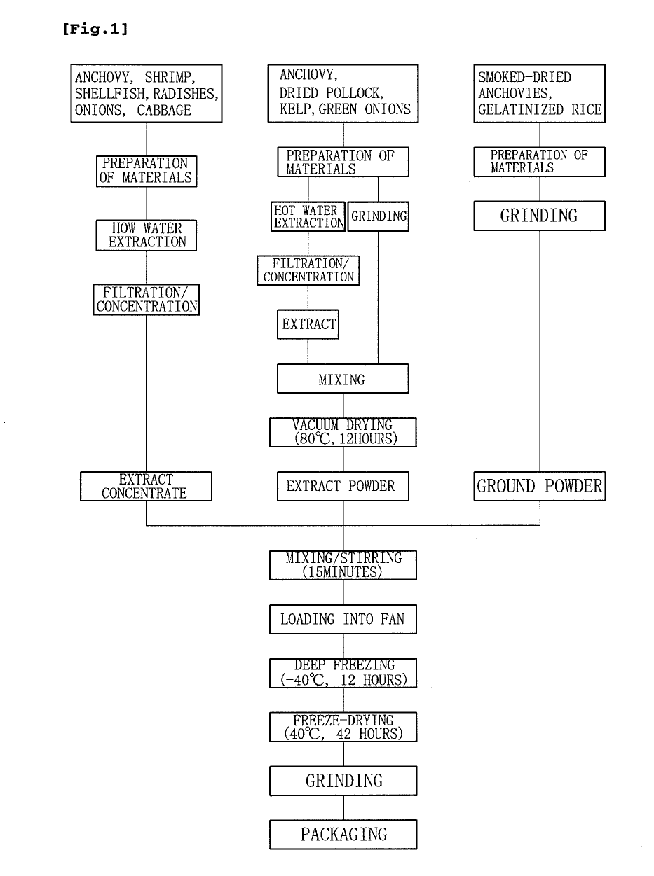

FIG. 2 is a comparison graph showing the time required to make 1-L base broths in Examples 2 to 4 and Comparative Examples 1 to 3.

FIGS. 3 and 4 are result graphs of evaluating storage periods of base broth-making materials.

### DETAILED DESCRIPTION OF THE INVENTION

Hereinafter, preferred embodiments of the present invention will be described in further detail with reference to Examples. However, it is clearly understood by those of ordinary skill in the art that these Examples are merely to explain the present invention, not to limit the scope of the present invention.

### Example 1

### Preparation of Materials for Base Broth Powder

Anchovies, shrimp, shellfish, radishes, onions and cabbage were prepared and hot water extracted, respectively, and the resulting extracts were filtered and concentrated under reduced pressure to make extract concentrates having 55 to 65 Brix, respectively.

Then, kelp, anchovies, dried pollock and green onions were prepared and hot water extracted, respectively. The resulting extracts were filtered and concentrated under reduced pressure to make the extract concentrates having 10 to 30 Brix. Meanwhile, each of kelp, anchovies, dried pollock and green onions was ground into powder. The extract concentrates and the powders were mixed, and the mixtures were dried at 80° C. in a vacuum for 12 hours and ground into powder, thereby obtaining an extract powder.

Subsequently, smoked-dried anchovies and rice flour were prepared, and 90% of the anchovies were passed through 25 mesh to provide a powder, and rice flour was gelatinized by drum-drying and ground into powder, thereby obtaining a ground powder.

### Example 2

### Preparation of Base Broth Powder

The extract concentrate, the extract powder and the ground powder prepared in Example 1 at a content ratio given in the following Table 1 were mixed for 15 minutes in a mixer. The resulting mixture was loaded into a drying fan and frozen at −40° C. in a deep freezer for 12 hours. The mixture was dried at 40° C. under reduced pressure for 42 hours, and ground into powder, thereby obtaining base broth powder.

TABLE 1
Composition of Materials for Base broth powder of Example 2

| Materials | Details of Materials | % by Weight |
|---|---|---|
| Extract Concentrate | Anchovies | 16 |
| | Shrimp | 1 |
| | Shellfish | 2 |
| | Radishes | 35 |
| | Onions | 12 |
| | Cabbage | 20 |
| Extract Powder | Kelp | 3 |
| | Anchovies | 5 |
| | Dried Pollock | 1 |
| | Green Onions | 1 |
| Ground Powder | Anchovies | 1 |
| | Rice | 3 |

The components of Table 1 can be expressed as component ratios of the respective materials as follow.

TABLE 1-1

| Natural Material | Details of Materials | % by Weight | % by Weight |
|---|---|---|---|
| Seafood | Anchovies | 22 | 29 |
| | Dried Pollock | 1 | |
| | Shrimp | 1 | |
| | Shellfish | 2 | |
| | Kelp | 3 | |
| Culinary Vegetables | Radish | 35 | 68 |
| | Onion | 12 | |
| | Cabbage | 20 | |
| | Green Onion | 1 | |
| Rice Flour | Rice Flour | 3 | 3 |

10 g of the base broth powder prepared as described above were added into 1 L of water and boiled. After boiling for another 5 minutes, a base broth was obtained.

### Examples 3 and 4

### Preparation of Base Broth Powder

Base broth powders were prepared in the same manner as in Example 2, except that seafood, culinary vegetables and rice flour were mixed at a mixing ratio as listed in the following Tables 2 and 3.

TABLE 2
Composition of Materials for Base broth powder of Example 3

| Materials | Details of Materials | % by Weight |
|---|---|---|
| Extract Concentrate | Anchovies | 20 |
| | Shrimp | 3 |
| | Shellfish | 2 |
| | Radish | 20 |
| | Onion | 10 |
| | Cabbage | 14.5 |
| Extract Powder | Kelp | 3 |
| | Anchovy | 8 |
| | Dried Pollock | 4 |
| | Green Onion | 0 |
| Ground Powder | Anchovy | 2 |
| | Rice | 3.5 |

TABLE 3
Composition of Base broth powder of Example 4

| Materials | Details of Materials | % by Weight |
|---|---|---|
| Extract Concentrate | Anchovies | 13 |
| | Shrimp | 1 |
| | Shellfish | 0 |
| | Radish | 40 |
| | Onion | 13 |
| | Cabbage | 20 |
| Extract Powder | Kelp | 2 |
| | Anchovy | 4 |
| | Dried Pollock | 1 |
| | Green Onion | 2 |
| Ground Powder | Anchovy | 1 |
| | Rice | 3 |

10 g of the base broth powders prepared in Examples 3 and 4 were added into 1 L of water and boiled. After boiling for another 5 minutes, the base broth was obtained.

### Comparative Example 1

The same materials as used in Example 1 (anchovies, dried pollock, shrimp, shellfish, kelp, radishes, onions, cabbage, green onions and rice flour) were prepared at the ratio given in Example 2, added into 1 L of water and boiled. After boiling for another 30 minutes, water was added to adjust the total amount to 1 L and a base broth was obtained.

### Comparative Example 2

A commercially available anchovy tea-bag [an anchovy tea-bag product from Badaone Co., Ltd. ( [symbol] , South Korea)] was purchased, put into 1 L of water and boiled for 15 minutes. Water was added to adjust the total amount to 1 L and a base broth was obtained.

### Comparative Example 3

1 L of a commercially available base broth-making liquid product [a Gukseonsaeng seafood product from Daesang Ltd. ( [symbol] , South Korea)] was measured and boiled for 5 minutes to produce a base broth.

### Experimental Example 1

### Measurement of Time Required for Making Base Broth

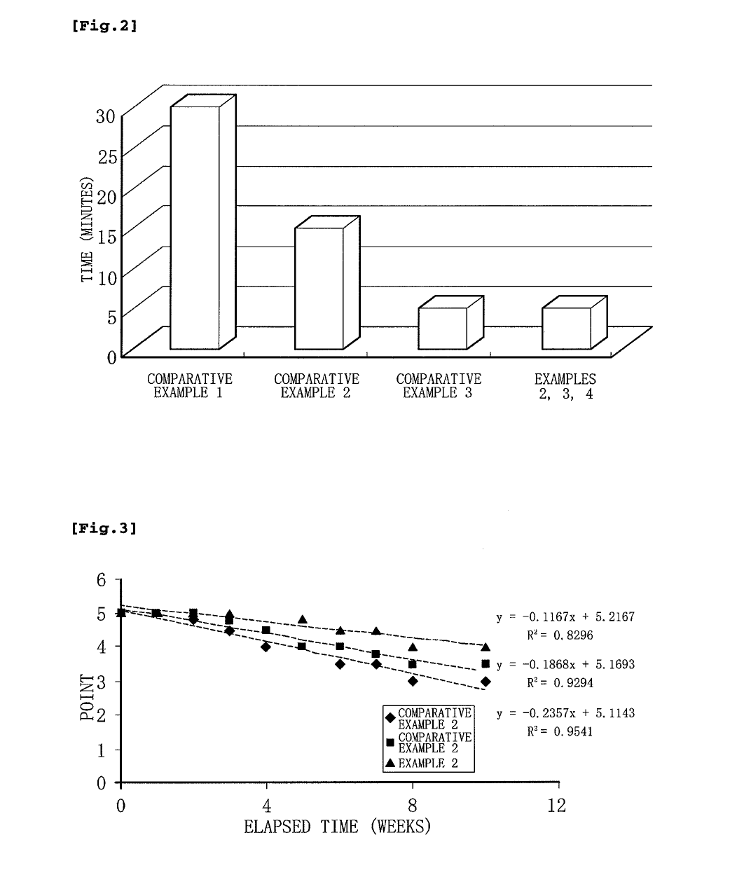

Time required for making 1 L of each of the base broths in Examples 2 to 4 and Comparative Examples 1 to 3 was measured, respectively, and compared. The results are shown in FIG. 2.

In the case of Comparative Example 1, it took more than 30 minutes to make the base broth at home or in a restaurant Kitchen. On the other hand, in the cases of Examples 2, 3 and 4 of the present invention, it took only approximately 5 minutes to make the base broth. Therefore, it concludes that the time required to make the base broth can be shortened by using the product of the present invention (see FIG. 2).

### Experimental Example 2

### Measurement of Storage Period of Base Broth-Making Materials

In order to determine storage periods of materials necessary for making a base broth in the Examples and Comparative Examples, an accelerated experiment was performed by storing the tea-bag product of Comparative Example 2, the liquid product of Comparative Example 3 and the products of Example 2 of the present invention in a dry oven at 45° C. for 8 weeks.

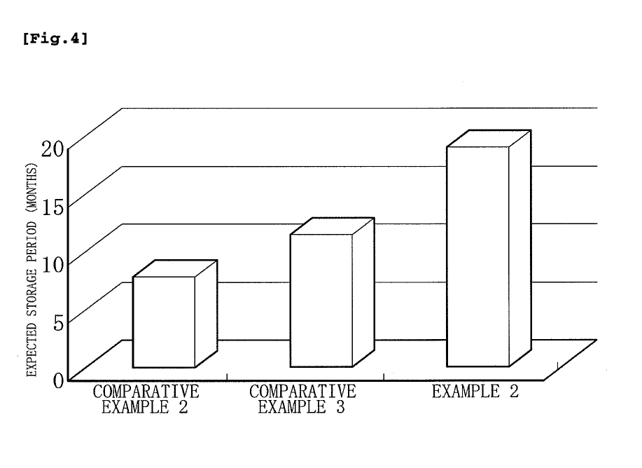

Since the properties and states of materials in each of Example 2 and Comparative Examples 2 and 3 are different (raw materials in Comparative Example 2, the liquids in Comparative Example 3 and the powders in Example 2), the objects of a sensory test were prepared according to the method of Experimental Example 1 and the sensory test was performed according to a 5-point rating scale method (5: very good, 4: good, 3: average, 2: poor, 1: very poor). It was assumed that the lower limit of quality was set to point 3, and a quality change constant, Q10, was set to 2. The results show that the base broths of Comparative Examples 2 and 3 had a storage period of 8 and 11 months, respectively, whereas the base broth of Example 2 had a storage period of approximately 18 months. Therefore, it concludes that the products of the present invention have the longest storage period (see FIGS. 3 and 4).

### Experimental Example 3

### Sensory Test

In order to evaluate the base broths prepared according to the Examples 2 to 4 and Comparative Examples 1 to 3 in sensory aspects, soybean-paste soup was made by using each of the base broth prepared in the Examples and the Comparative Examples, and 20 (twenty) trained sensory panels tasted the soybean-paste soup for a sensory test. Each of the soybean-paste soup was prepared as follows: 45 g of soybean paste were added into base broth and stirred homogeneously. After boiling, 100 g of cabbage heart, 6 g of chopped garlic and 6 g of green onions were added and boiled for another 15 minutes. A 5-point rating scale method was used for determining sensory test point. (5: very good, 4: good, 3: average, 2: poor, 1: very poor). The results are listed in the following Table 4.

TABLE 4

| | | | Anchovy | | |
|---|---|---|---|---|---|
| | | Anchovy | Flavor | Savory | |
| | Rich Taste | Taste | Intensity | Taste | Total |
| Comparative | 3.3 | 3.4 | 3.1 | 3.2 | 3.3 |
| Example 1 | | | | | |
| Comparative | 3.2 | 3.4 | 3.4 | 3.3 | 3.3 |
| Example 2 | | | | | |
| Comparative | 3.4 | 3.3 | 3.0 | 3.3 | 3.4 |
| Example 3 | | | | | |
| Example 2 | 3.8 | 3.7 | 3.7 | 3.6 | 3.7 |
| Example 3 | 3.7 | 3.8 | 3.8 | 3.4 | 3.6 |
| Example 4 | 3.7 | 3.5 | 3.8 | 3.5 | 3.6 |

As can be seen from the results of the sensory test of Table 4, the conventional base broth-making methods or products were not satisfactory since they cannot provide a rich taste and a strong anchovy taste. On the other hand, in the case of a base broth powder obtained by mixing the concentrate extracted from the anchovies, the shrimp, the shellfish, the radishes, the onions and the cabbage, the extract powder from the anchovies, the dried pollock, the kelp and the green onions, and the ground powder of the anchovies and the gelatinized rice, freeze-drying the resulting mixture and grinding it into powder, it provides a base broth whose taste is totally superior to the conventional methods or products, in view of its richer taste and stronger anchovy taste. While the invention has been shown and described with reference to certain exemplary embodiments thereof, it will be understood by those skilled in the art that various changes in form and details may be made therein without departing from the spirit and scope of the invention as defined by the appended claims.

1. A method of producing a base broth powder composition, comprising:
preparing a concentrate extracted from anchovies, shrimp, shellfish, radishes, onions and cabbage;
preparing an extract powder from kelp, anchovies, dried pollock and green onions;
preparing a ground powder of anchovies and gelatinized rice flour;
mixing and homogenizing the extract concentrate, the extract powder and the ground powder;
freeze-drying the homogenized mixture; and
grinding the resultants into powder.

2. A base broth powder composition produced by the method of claim 1.

3. The base broth powder composition according to claim 2, wherein the base broth powder composition comprises 15 to 45% by weight of seafood including anchovies, dried pollock, shrimp, shellfish and kelp, 50 to 75% by weight of culinary vegetables including radishes, onions, cabbage and green onions, and 1 to 5% by weight of gelatinized rice flour.

4. The method according to claim 2, wherein the base broth powder composition comprises 15 to 35% by weight of the anchovies, 0.5 to 5% by weight of the dried pollock, 0.5 to 5% by weight of the shrimp, 0 to 4% by weight of the shellfish, 1 to 6% by weight of the kelp, 25 to 35% by weight of the radishes, 8 to 15% by weight of the onions, 12 to 22% by weight of the cabbage, 0 to 2% by weight of the green onions and 1 to 5% by weight of the gelatinized rice flour.
